(19) United States
(12) Patent Application Publication
(10) Pub. No.: US 2006/0202918 A1
(43) Pub. Date: Sep. 14, 2006

(54) Multi-scan device and multi-scan method for plasma display panel

(76) Inventor: Tae Hyung Kim, Seoul (KR)

Correspondence Address: FLESHNER & KIM, LLP, P.O. BOX 221200, CHANTILLY, VA, 20153, US

(21) Appl. No.: 11/371,225

(22) Filed: Mar. 9, 2006

(30) Foreign Application Priority Data
Mar. 9, 2005 (KR) 10-2005-0019448

(51) Int. Cl. G09G 3/28

(52) U.S. Cl. 345/60

(57) ABSTRACT

A multi-scan device and a multi-scan method for a plasma display panel is provided wherein data signals forming one frame (or sub-frame) relative to each line are compared, and data signals having the same line are simultaneously scanned based on the comparison. A scanning time may be decreased by simultaneously scanning the lines having the same data signals such that a sustain time for generating light can be increased and an image having a sufficient brightness can be displayed on a screen.

This application claims priority to an application filed in the Korean Industrial Property Office on Mar. 9, 2005, and assigned serial No. 10-2005-0019448, the contents of which are incorporated herein by reference.

### BACKGROUND OF THE INVENTION

1. Field of the Invention

The present invention relates to a multi-scan device and a multi-scan method for plasma display panel.

2. Background of Related Art

Recently, special attention is paid on enhancement of high quality of display devices. Particularly, with the special attention increasing on FPDs (Flat Panel Displays), advancement or emergence of next generation image display devices such as LCDs (Liquid Crystal Displays), OLEDs (Organic Light Emitting Diodes), PDPs (Plasma Display Panels) and FEDs (Field Emission Displays) increases to replace CRTs (Cathode Ray Tubes).

The plasma display panel, which is one of the FDPs, has many advantages over the LCD in that it is easy to make a large dimension screen, light weight (approximately ⅙ of weight of CRT) and has an excellent wide viewing angle of over 160 degrees. The plasma display panel has other advantages in that its screen has an excellent uniformity and the panel is not affected by terrestrial magnetic field, such that the trend is that its use is on the increase.

The plasma display panel may be arranged in a matrix of m columns and n rows. The plasma display panel is such that a plurality of address electrodes are arranged in the column direction, and a plurality of scan electrodes and sustain electrodes are arranged in pairs in the row direction. Furthermore, the plasma display panel is such that light is emitted by the voltage applied to a cell situated at an intersection among the address electrodes, the scan electrodes and sustain electrodes. The plasma display panel may radiate a fluorescent body (R,G,B) using a vacuum ultraviolet (VUV) with a wavelength of 147 nm generated upon discharge of an inactive mixture gas, such as He+Xe, Ne+Xe or He+Ne+Xe, to thereby display pictures including characters and graphics. The discharge has a sustain period holding for a predetermined period of time by a power source applied to the sustain electrode.

The plasma display panel displays images by discharge generated by an electric potential difference applied to the scan electrodes and address electrodes. The plasma display panel is sequentially applied line by line at scan electrodes thereof with voltage from an uppermost scan electrode toward the column direction. However, if the power source is sequentially applied line by line to all the lines of the plasma display panel, the plasma display panel may suffer from degraded brightness of images.

FIG. 1 is a block diagram illustrating a configuration of a plasma display panel. Referring to FIG. 1, the scan device of the plasma display panel includes a data signal driving unit 100, a scan signal driving unit 110 and a plasma display panel 120.

The data signal driving unit 100 receives a data signal on an image and outputs the data signal to a data electrode of the plasma display panel 120. The row direction of address electrodes arranged on the plasma display panel 120 is applied with the data signal outputted by the data signal driving unit 100.

The scan signal driving unit 110 sequentially outputs scan signals one at a time in the row direction of the plasma display panel 120. The row direction of the scan electrodes arranged in row lines on the plasma display panel 120 is applied with the scan signal outputted by the scan signal driving unit 110.

The plasma display panel 120 is operated in such a manner that discharge is created between the scan electrodes applied with voltage in response to the scan signal outputted by the scan signal driving unit 110 and the address electrodes applied with voltage in response to the data signal outputted by the data signal driving unit 100. Images are displayed on the lines of the scan electrodes of the plasma display panel 120 applied with the scan voltage. For example, the scan signal driving unit 110 sequentially outputs scan signals one at a time along the row direction of the plasma display panel from the scan electrode located at the uppermost end to the scan electrode of the lowermost end. The fluorescent material of each cell located at the scan electrode applied with the scan signal emits visible light by ultraviolet rays generated by discharge between the scan electrode and the address electrode. The scan electrodes applied with scan signals by the emission of the fluorescent material are displayed with images, and the discharge is maintained by the sustain electrodes.

However, the scan device of a plasma display panel is such that all the scan electrodes of plasma display panel are sequentially selected by the data signal and scan signals are applied. In other words, as shown in FIG. 2, the plasma display panel 120 sequentially selects the scan electrodes (L₁, L₂, . . . , L_{N}) one at a time and applies scan signals to display a predetermined image on the plasma display panel 120. Consequently, the scan time occupying in the entire driving time driving the plasma display panel is long, while a sustain time holding the discharge is relatively short. This may result in insufficient brightness or luminance of the images displayed on a screen of the plasma display panel.

For example, for a VGA (Video Graphic Array) comprising 480 display lines at 12 subfields per field sequentially applied to a scan electrode, the scan time takes 8.64 ms which is 52% of an entire driving time. For a XGA (Extended Graphic Array) comprising 768 display lines at 12 subfields per field sequentially applied to a scan electrode, the scan time takes 13.8 ms which is 82.8% of the entire driving time.

There are disadvantages in the scan device of the plasma display panel thus described in the aforementioned explanation in that the scan time takes the large share of the total driving time, thereby resulting in decreased sustain time and insufficient brightness of images displayed on a screen of the plasma display panel.

### SUMMARY OF THE INVENTION

It is an object of the present invention to provide a multi-scan device and a multi-scan method for a plasma display panel (PDP) configured to reduce a scan time by simultaneously scanning a plurality of scan lines where each line has a same data signal in the plasma display panel.

Another object is to provide a multi-scan device and a multi-scan method for a plasma display panel configured to display an image of sufficient luminance on a screen by way of increased sustain time in response to the reduced scan time in the plasma display panel.

In accordance with the object of the invention, data signals of each line comprising one frame is compared per pixel to extract lines having the same data signals. If the lines having the same extracted data signals are scanned, scan signals may be simultaneously generated to reduce an entire time generating the scan signals.

Therefore, a multi-scan device of a plasma display panel according to one embodiment of the present invention comprises: data signal storage for storing data signals for each scan line of the plasma display panel; a data signal comparator for discriminating whether data signals of each scan line stored in the data signal storage are identical by comparing the data signals; a same data signal line position storage for forming as respective sets positions of scan lines each having the identical data signal and storing the positions as a comparative result of the data signal comparator; a scan line selector for using the sets of positions of the scan lines each having the same data signal stored in the same data signal line position storage to select lines (to be scanned); a scan signal driving unit for inputting the scan signals to the lines (to be scanned) selected by the scan line selector; a data signal driving unit for receiving the data signal relative to the lines (to be scanned) selected by the scan line selector among the data signals stored in the data signal storage and outputting the data signal to the plasma display panel; and a controller for controlling in such a manner that the lines to be scanned by the scan line selector are not repeatedly selected.

The line (to be scanned) selected by the scan line selector may be more than one.

The data signal storage may store one data signal relative to one frame (or relative to one sub-frame.

The data signal driving unit may receive a data signal relative to the line (to be scanned) selected by the scan line selector out of the data signals stored in the data signal storage and outputs the data signal to the panel.

The data signal driving unit may receive a data signal relative to one line out of a plurality of lines (to be scanned) selected by the scan line selector if the number of lines (to be scanned) selected by the scan line selector are plural.

The scan line selector may comprise a simultaneous scan discriminator for using a set of locations of lines having the same data signal stored in the same data signal location storage to discriminate whether there is present a line to be simultaneously scanned with the line (to be scanned) inputted from the controller and for outputting an enable signal relative to the line (to be scanned); a scan line location storage for using the enable signal outputted by the simultaneous scan discriminator to store the locations of the lines to be scanned; and a scan discriminator for discriminating whether the line (to be scanned) received from the controller has been already scanned by using the locations of the lines (to be scanned) stored in the scan line position storage.

The scan discriminator may sequentially receive lines one at a time from a line located at an uppermost end of the plasma display panel to a lowermost end of the plasma display panel.

The simultaneous scan discriminator may receive a line (to be scanned) discriminated by the scan discriminator as not having been already scanned out of lines (to be scanned) received from the controller.

A multi-scan method of a plasma display panel according to another embodiment of the present invention may comprise storing data signals of each line to be displayed on the plasma display panel; comparing the stored data signals to extract lines having the same data signal; selecting lines to be scanned; and generating scan signals so that the lines having the same data signals as the selected lines (to be scanned) can be simultaneously scanned.

The comparing the data signals may include mutually comparing all the data signals of each line comprising one frame. The mutual comparison of the data signals is to compare the data signals of each line per pixel. The comparison of the data signals is to compare if data signals of all the lines comprising one frame are all stored. The selection of lines to be scanned is to sequentially select one at a time from a line situated at an upper end of the plasma display panel to a line situated at a lower end of the plasma display panel.

The selection of lines to be scanned is to sequentially select one at a time from a line situated at each upper end of an upper panel and a lower panel of the plasma display panel to a line situated at a lower end if the plasma display panel is a dual scan method.

The generating the scan signals may comprise discriminating whether the line having the same data signal as that of the selected line has been extracted; and generating scan signals in order to simultaneously scan the selected line and the line having the same data signal if the line having the same data signal has been extracted.

Furthermore, the generating the scan signals may further comprise generating scan signals in order to scan only the selected line if the line having the same data signal has not been extracted. The generating the scan signals may further comprise skipping the generation of the scan signals if the selected line is the line erstwhile scanned.

### BRIEF DESCRIPTION OF THE DRAWINGS

FIG. 1 is a block diagram illustrating a construction of a scan device of a plasma display panel.

FIG. 2 is a block diagram illustrating operation of a scan device of a plasma display panel.

FIG. 3 is a block diagram illustrating a configuration of a multi-scan device of a plasma display panel according to the present invention.

FIG. 4 is a block diagram illustrating a detailed construction of a scan line selector of FIG. 3.

FIG. 5 is a flowchart illustrating a multi-scan method of a plasma display panel according to the present invention.

FIGS. 6 and 7 are schematic drawings illustrating operation of scan signals applied to a plasma display panel of single scan and dual scan methods in response to the multi-scan method of the present invention.

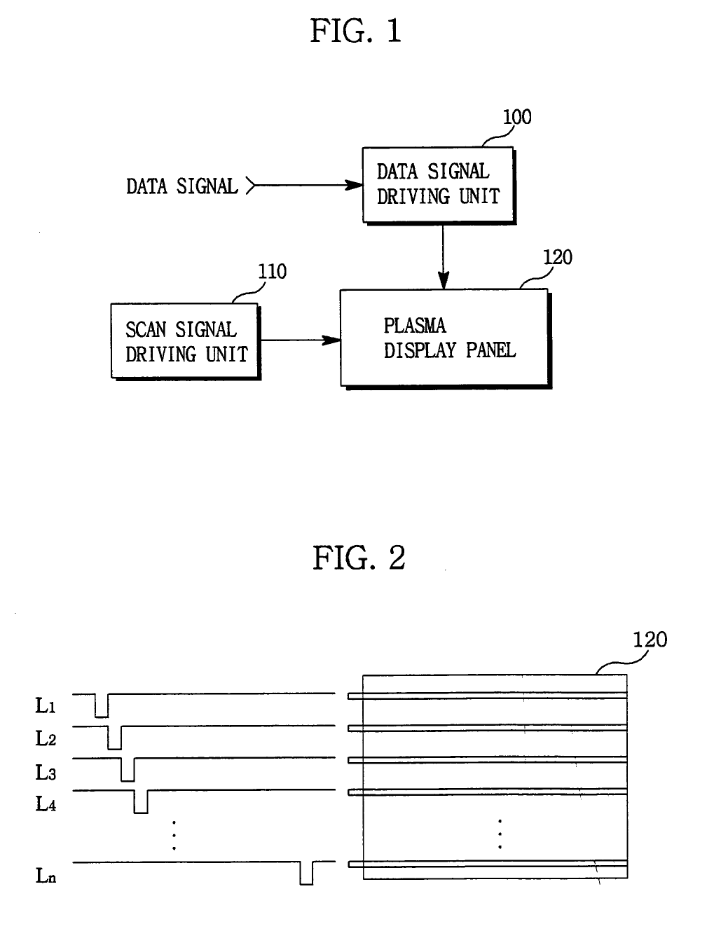

### DETAILED DESCRIPTION OF PREFERRED EMBODIMENTS

Various plasma display apparatus and driving methodology are described in U.S. patent application Ser. Nos. 11/330,995, filed Jan. 13, 2006; Ser. No. 11/281,439, filed Mar. 18, 2005; Ser. No. 11/325,333, filed Jan. 5, 2006; and Ser. No. 11/249,278, filed Feb. 8, 2006, the subject matter of which are incorporated herein by reference.

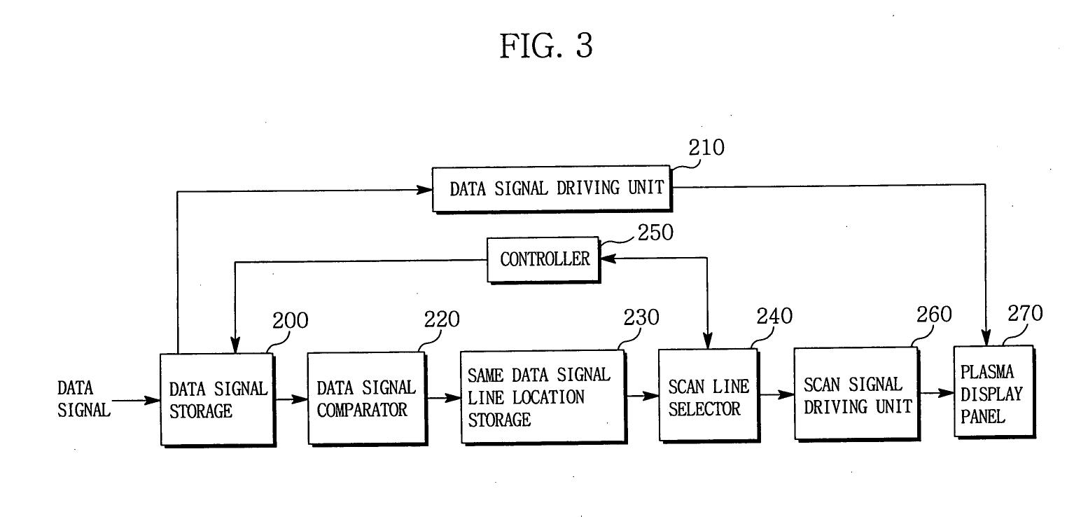

FIG. 3 is a block diagram illustrating a construction of a multi-scan device of a plasma display panel according to the present invention. As shown, the multi-scan device of the plasma display panel includes a data signal storage 200, a data signal driving unit 210, a data signal comparator 220, a same data signal line position storage 230, a scan line selector 240, a controller 250, a scan signal driving unit 260 and a plasma display panel 270.

The data signal storage 200 receives image data signals of each line in a row direction of the plasma display panel 270. In storing the inputted data signals, the data signal storage 200 stores a data signal for one frame (and/or one sub-frame). In other words, the data signal storage 200 stores data signals of all the lines constituting one frame (or one sub-frame).

The data signal storage 200 outputs the data signals corresponding to each scan line to be scanned to the data signal driving unit 210. In situations of simultaneously scanning a plurality of lines, the data signal storage 200 outputs only a data signal relative to one scan line for the data signals corresponding to a plurality of lines. The reason is that, if a plurality of lines are simultaneously scanned, the data signals are the same for the plurality of scan lines. Accordingly, even if a data signal corresponding to one scan line of the plurality of lines to be simultaneously scanned is outputted from the data signal storage 200, the image displayed on the panel 270 is not affected. For example, if a fifth line and a tenth line are to be simultaneously scanned, the data signal storage 200 selects only one data signal from the stored data signals corresponding to the fifth line and the tenth line and outputs the one data signal to the data signal driving unit 210.

The data signal driving unit 210 receives the data signals outputted by the data signal storage 200 and outputs the signals to the plasma display panel 270. As mentioned above, the data signal driving unit 210 receives a data signal (rather than a plurality of data signals) from the data signal storage 200 for one scan line if a plurality of lines are to be simultaneously scanned.

The data signal comparator 220 receives all the data signals of one frame stored in the data signal storage 200. The data signal comparator 220 mutually compares data signals of each line. The data signal comparator 220, which is, for example, a comparator, is not limited to comparing data signals but may also compare data signals of each line as means for comparing the data signals.

The same data signal line position storage 230 receives comparative results of the data signal comparator 220 of the data signals corresponding to each line. The same data signal line position storage 230 forms and stores as one set the locations of the lines where the corresponding data signals are the same. For example, if data signals of a first line, a fifth line and a tenth line are the same, and data signals of a second line and a sixth line are the same, the same data signal line position storage 230 forms and stores as one set the first line, the fifth line and the tenth line, and forms and stores as another set the second line and the sixth line.

The scan line selector 240 selects lines to be scanned and outputs enable signals corresponding to the lines to be scanned. For example, the scan line selector 240 simultaneously selects a plurality of lines if a plurality of lines have a corresponding same data signal, and the scan line selector 240 outputs an enable signal to the selected plurality of lines. An example construction of selecting lines to be scanned by the scan line selector 240 will be described below.

The controller 250 outputs to the scan line selector 240 scan lines (or information corresponding to the scan lines) by sequentially selecting one scan line from the uppermost end to the lowermost end of the plasma display panel 270 (or alternatively from the lowermost end to the uppermost end). In selecting lines to be scanned by the scan line selector 240, the controller 250 controls operations such that scan lines are not repeatedly selected for a particular frame (and/or sub-frame). An example construction of the controller 250 controlling the scan line selector 240 will be described below.

The scan signal driving unit 260 receives the enable signal(s) outputted by the scan line selector 240 and outputs a scan signal to each scan electrode of the plasma display panel 270. The scan signal driving unit 260 outputs a scan signal to a relevant scan electrode if an enable signal relative to a particular scan line is received from the scan line selector 240. If the received enable signal is relative to a plurality of lines, then the scan signal driving unit 260 applies the scan signal to the scan electrode(s) corresponding to the plurality of lines.

The plasma display panel 270 applies to each cell of the scan electrode and address electrode the data signals and scan signals received from the data signal driving unit 210 and the scan signal driving unit 260. All the cells of the scan electrodes to which the scan signals are inputted may create a discharge by an electric potential difference between the scan electrodes and the address electrodes for displaying images on a screen. The discharge generated at the cells is maintained for a predetermined time by sustaining signals during a sustain period.

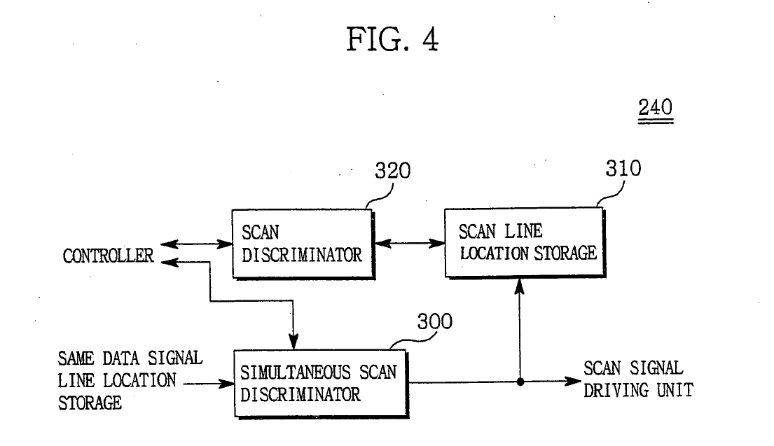

FIG. 4 is a block diagram illustrating a detailed construction of a scan line selector of FIG. 3. As shown, the scan line selector 240 may include a simultaneous scan discriminator 300, a scan line location (or position) storage 310 and a scan discriminator 320.

The simultaneous scan discriminator 300 may discriminate (or determine) whether scan lines to be simultaneously scanned are present. In other words, the simultaneous scan discriminator 300 discriminates (or determines) whether there are lines having a same data signal as the line to be currently scanned (or presently scanned). The scan lines to be currently scanned are received from the controller 250. In discrimination thereof, the simultaneous scan discriminator 300 may use the set of the line locations stored in the same data signal line location storage 230. If lines are present having same data signals as the data signals corresponding to the lines to be currently scanned, then the simultaneous scan discriminator 300 outputs an enable signal to the plurality of lines so that lines having the same data signals can be simultaneously scanned. However, if lines are not present having same data signals as the data signals corresponding to the lines to be currently scanned, then the simultaneous scan discriminator 300 outputs an enable signal relative to the line to be currently scanned.

For example, if a line to be currently scanned received from the controller 250 is a tenth line, the simultaneous scan discriminator 300 discriminates (or determines) whether a line having the same data signal as the data signal corresponding to the tenth line is present based on the set of locations stored in the same data signal line location storage 230. As a result of the discrimination, if the data signals corresponding to the tenth line and the thirteenth line are the same, the simultaneous scan discriminator 300 outputs to the scan signal driving unit 260 an enable signal relative to each line so that the tenth line and the thirteenth line can be simultaneously scanned.

The scan line location storage 310 uses the enable signal outputted by the simultaneous scan discriminator 300 to store a location of the line to be scanned. The location of the line to be scanned is determined by the enable signal outputted by the simultaneous scan discriminator 300. Therefore, the scan line location storage 310 can store the location of the line to be scanned by storing the location of the relevant line into which the enable signal is inputted.

The scan discriminator 320 discriminates (or determines) whether the line to be currently scanned output from the controller 250 is stored in the scan line position storage 310. In other words, the scan discriminator 320 discriminates (or determines) whether the line to be currently scanned is a line that has already been scanned. The lines to be currently scanned are inputted one at a time (along the row direction) from a line located at the uppermost end of the panel to the lowermost end of the plasma display panel (or alternatively from the lowermost end to the uppermost end). The scan discriminator 320 outputs to the controller 250 a signal determining that the line to be scanned has been already scanned if the line (to be currently scanned) inputted from the controller 250 is stored in the scan line location storage 310. The controller 250 having received a signal determining that the line has been already scanned controls operations such that the line (to be scanned) is not inputted into the simultaneous scan discriminator 300. In other words, the controller 250 controls operations such that the line (to be scanned) is not inputted into the simultaneous scan discriminator 300 by way of the determining signal outputted from the scan discriminator 320, so that the same line is prevented from being repeatedly scanned in the one frame. The scan discriminator 320 repeatedly receives the location of the line (to be scanned) from the controller 250, and discriminates (or determines) whether the inputted line (to be scanned) has been already scanned.

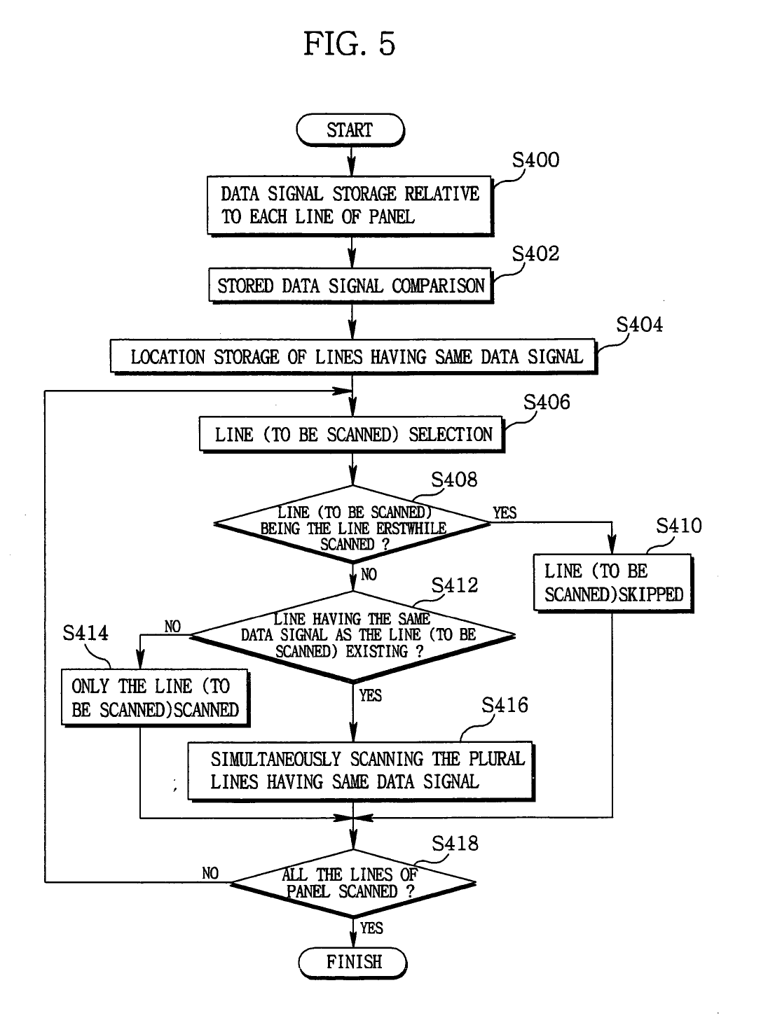

FIG. 5 is a flowchart illustrating a multi-scan method of a plasma display panel according to the present invention. Referring to FIG. 5, data signals relative to each scan line of the panel are stored (S400). The data signal storage 200 stores the data signals relative to each line of the panel. In other words, the data signal storage 200 receives and stores the data signal relative to one frame, in storing the inputted data signals. Alternatively, the data signal storage 200 may receive and store data signals relative to one sub-frame.

The stored data signals are compared (S402). In other words, the data signal comparator 200 compares the data signals relative to each line stored in the data signal storage 200 on a pixel basis.

A location of lines having the same data signal is stored (S404). The same data signal line location storage 230 receives a result of the comparison by the data signal comparator 220. The same data signal line position storage 230 uses the comparative result thus received to form and store as one set the location of the lines having a same data signal.

Lines to be scanned are selected (S406). The controller 250 sequentially selects a line (to be scanned) from a line at the uppermost end of the plasma display panel 270 to a line at the lowermost end (S406). A discrimination is made whether the line (to be scanned) is one that has been already scanned (S408). The scan discriminator 320 discriminates whether the line (to be scanned) received from the controller 250 is stored in the scan line location storage 310. The scan line location storage 310 uses the enable signal outputted by the simultaneous scan discriminator 300 to store the location of the line (to be scanned). Because the line corresponding to the enable signal outputted by the simultaneous scan discriminator 300 is scanned, the scanned line is stored in the scan line location storage 310 by storing the scan line corresponding to the enable signal. Accordingly, the scan discriminator 320 can determine whether the line (to be scanned) received from the controller 250 via the scan line location storage 310 has been already scanned (for a particular frame or sub-frame).

As a result of discrimination at step S408, if the line (to be scanned) is one that has been already scanned (for a particular frame or sub-frame), the line to be scanned is skipped (S410). As a result of the discrimination by the scan discriminator 320, if the line (to be scanned) received from the controller 250 is one that has been previously scanned (during the frame and/or sub-frame), the scan discriminator 320 outputs a discrimination signal to the controller 250. The controller 250 having received the discrimination signal interrupts an input of the line (to be scanned) into the simultaneous scan discriminator 300. The line is scanned by the enable signal outputted by the simultaneous scan discriminator 300, where the line (to be scanned) is skipped by not allowing the line (to be scanned) to be inputted into the simultaneous scan discriminator 300. In other words, it is because the meaning that the line (to be scanned) is not inputted into the simultaneous scan discriminator 300 denotes that the scanning of relevant line is skipped.

As a result of the discrimination at S408, if the line (to be scanned) is not a line previously scanned, a discrimination (or determination) is made whether a line having the same data signal as the line (to be scanned) is present (S412). If the controller 250 has received from the scan discriminator 320 a signal determining that the line (to be scanned) is not a line previously (or erstwhile) scanned, the controller 250 controls operations such that the line (to be scanned) is inputted into the simultaneous scan discriminator 300. The simultaneous scan discriminator 300 discriminates whether there exists a line to be simultaneously scanned with the line (to be scanned) received from the controller 250. In the simultaneous scan discriminator 300 discriminating whether there is available a line to be scanned at the same time, the data signal stored in the same data signal line location storage 230 uses the set of the lines.

As a result of the discrimination at S412, if there exists no line having the same data signal as the line (to be currently scanned), only the line (to be currently scanned) is scanned (S414). The simultaneous scan discriminator 300 determines that there exists no line to be simultaneously scanned if there is no line having the same data signal as the line (to be scanned) received from the controller 250. In response to the discrimination, the simultaneous scan discriminator 300 outputs an enable signal relative to the line (to be scanned) received from the controller 250. The scan signal driving unit 260 outputs a scan signal to an electrode of a line corresponding to the enable signal outputted by the simultaneous scan discriminator 300. For example, if a line (to be scanned) received from the controller 250 is a third line and if it is determined that there exists no line having the same data signal as the third line as a result of the discrimination by the simultaneous scan discriminator 300, then the simultaneous scan discriminator 300 outputs to the scan signal driving unit 260 an enable signal relative to the third line. The scan signal driving unit 260 outputs the scan signal to a scan electrode corresponding to the third line so that only the third line can be scanned in response to the enable signal thus received. In other words, the scan signal driving unit 260 applies the scan signal to the third scan line.

As a result of the discrimination at S412, if there is present a line having the same data signal as the line (to be scanned), a plurality of lines each having the same data signal are simultaneously scanned (S416). If it is determined that a line having the same data signal as the line (to be scanned) received from the controller 250 is present, the simultaneous scan discriminator 300 outputs to the scan signal driving unit 260 an enable signal relative to the line to be simultaneously scanned with the line (to be scanned) received from the controller 250. The scan signal driving unit 260 outputs a scan signal in such a manner that the plurality of lines are simultaneously scanned in response to the inputted enable signal. For example, if the line (to be scanned) the simultaneous scan discriminator 300 has received from the controller 250 is the third line, the simultaneous scan discriminator 300 discriminates whether there is present a line having the same data signal as the data signal corresponding to the third line. As a result of the discrimination, if the data signal corresponding to a twelfth line is the same as the data signal corresponding to the third line, the simultaneous scan discriminator 300 outputs to the scan signal driving unit 260 enable signals relative to the third and twelfth lines. The scan signal driving unit 260 simultaneously outputs the scan signals to scan electrodes corresponding to the third line and the twelfth line in response to the inputted enable signals. In other words, the scan signal driving unit 260 applies the scan signals to the third and twelfth scan electrodes.

A discrimination (or determination) is made whether all the lines of the plasma display panel 270 have been scanned (S418). If all the lines of the plasma display panel 270 have been scanned, one frame is formed. Because the data signal storage 200 is stored with data signals relative to the one frame, a discrimination (or determination) is made as to whether all the lines of the plasma display panel 270 have been scanned so that a data signal relative to next frame can be stored at the data signal storage 200 to allow an image of the next frame to be displayed. Because the controller 250 selects the data signal (to be scanned) on a per line basis from the uppermost end of the plasma display panel 270 to the lowermost end, the controller 250 can discriminate whether all the lines of the plasma display panel 270 have been scanned by whether the controller 250 has selected the line located at the lowermost end of the plasma display panel 270 as a data signal to be scanned.

As a result of the discrimination at S418, if all the lines of the plasma display panel 270 have not been scanned, this means that one frame has not been formed such that the controller 250 outputs to the scan discriminator 320 a line adjacent to the line (to be scanned) thus selected.

As a result of the discrimination at S418, if all the lines of the panel 270 have been scanned, the data signal storage 200 stores a data signal relative to the next frame of the frame formed by the data signal of the scanned line.

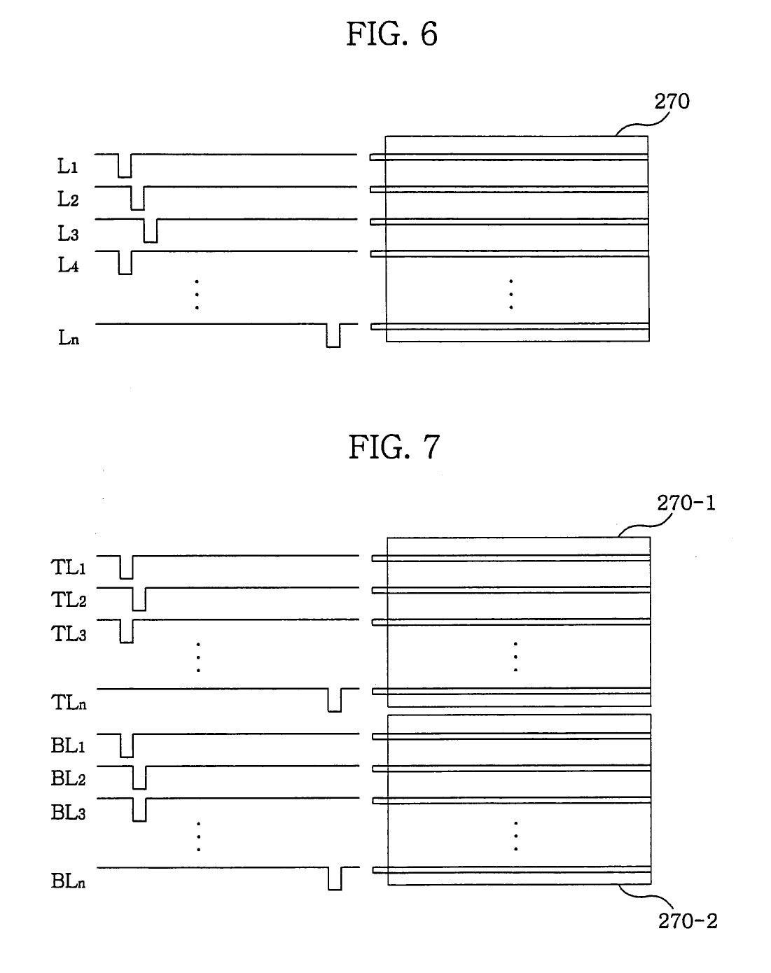

In other words, as illustrated in FIG. 6, if it is assumed that data signals of a first line (L₁) and a fourth line (L₄) of the plasma display panel 270 are identical (or similar), a scan signal is simultaneously applied to a scan electrode corresponding to the fourth line (L₄) when a scan signal is applied to a scan electrode corresponding to the first line (L₁), and a time for scanning the scan electrode corresponding to the fourth line (L₄) is skipped.

The present invention may also be applied to a plasma display panel of dual scan method. In a dual scan method, upper data electrodes and lower data electrodes may each be driven with data signals from separate drive circuits. As illustrated in FIG. 7, if it is assumed that data signals of a first line (TL₁) and a third line (TL₃) from an upper panel (270-1) are identical, and data signals of a second line (BL₂) and a third line (BL₃) from a lower panel (270-2) are identical, the upper panel (270-1) may simultaneously apply scan signals to scan electrodes corresponding to the first line (TL₁) and the third line (TL₃), and the lower panel (270-2) may simultaneously apply scan signals to scan electrodes corresponding to the second line (BL₂) and the third line (BL₃).

Consequently, there are advantages in the multi-scan device and method thus described according to the present invention in that time for applying scan signals to all the scan electrodes of the plasma display panel 270 can be reduced, and sustain time can be increased to enable to enhance the brightness of images displayed on the plasma display panel 270.

Embodiments of the present invention have been described with respect to the storing of data signals and the driving of scan lines relative to one frame. However, embodiments of the present invention are also applicable to the storing and/or driving of scan lines for only one sub-frame. In other words, the various operations discussed above may also be applicable to discriminations/determinations for one sub-frame.

While specific embodiments have been described, it is evident that many alternatives, modifications, permutations and variations will become apparent to those skilled in the art in light of the foregoing description. Accordingly, reference should be made to the following claims, rather than to the foregoing specification, as indicating the scope of the invention. In this regard, the description above is intended by way of example only and is not intended to limit the present invention in any way, except as set forth in the following claims.

What is claimed is:

1. A multi-scan device of a plasma display panel comprising:
a data signal storage for storing data signals corresponding to scan lines of the plasma display panel;
a data signal comparator for determining whether the stored data signals corresponding to each scan line are similar by comparing the stored data signals;
a same data signal line position storage for storing at least one set of scan lines having the similar data signal based on the results of the data signal comparator;
a scan line selector for selecting scan lines based on the set of the scan lines stored in the same data signal line position storage;
a scan signal driving unit for outputting scan signals to the scan lines selected by the scan line selector; and
a controller for controlling the scan line selector to avoid repeated selection by the scan line selector.

2. The device of claim 1, wherein the scan line selector selects a plurality of scan lines to be simultaneously scanned when a plurality of scan lines have corresponding similar data signals.

3. The device of claim 1, wherein the data signal storage stores the data signals relative to one frame.

4. The device of claim 1, wherein the data signal storage stores the data signals relative to one sub-frame.

5. The device of claim 1, further comprising:
a data signal driving unit for receiving a data signal corresponding to the scan line selected by the scan line selector from the data signals stored in the data signal storage, and the data signal driving unit for outputting the received data signal to the panel.

6. The device of claim 5, wherein the data signal driving unit receives one data signal corresponding to a plurality of scan lines if a number of lines selected by the scan line selector is greater than one.

7. The device of claim 1, wherein the scan line selector comprises:
a simultaneous scan discriminator for determining whether scan lines are to be scanned simultaneously based on the set of scan lines having the similar data signal stored in the same data signal location storage, and the simultaneous scan discriminator for outputting an enable signal relative to at least one line to be scanned;
a scan line location storage for storing locations of the lines to be scanned based on the enable signal outputted by the simultaneous scan discriminator; and
a scan discriminator for determining whether the line to be scanned has been already scanned based on the locations of the lines to be scanned stored in the scan line location storage.

8. The device of claim 7, wherein the scan discriminator receives information identifying lines sequentially one at a time from a line at an upper end of the plasma display panel to a line at a lower end of the plasma display panel.

9. The device of claim 7, wherein the simultaneous scan discriminator receives information identifying a line to be scanned when the scan discriminator determines that the scan line has not yet been scanned for a particular frame or sub-frame.

10. A multi-scan method of a plasma display panel comprising:
storing data signals of each line to be displayed on a plasma display panel;
comparing the stored data signals to determine lines having the same data signal;
selecting lines to be scanned based on the comparing; and
generating scan signals so that lines having the same data signals can be simultaneously scanned.

11. The method of claim 10, wherein scan electrodes receiving the simultaneously generated scan signals are applied with data signals from same data electrodes.

12. The method of claim 10, wherein the comparing the stored data signals includes comparing all the data signals of each line for one frame.

13. The method of claim 12, wherein the comparing the stored data signals includes comparing the data signals of each line for one frame on a per pixel basis.

14. The method of claim 10, wherein the comparing the stored data signals includes comparing all the data signals of each line for one sub-frame.

15. The method of claim 10, wherein selecting the lines to be scanned includes sequential selecting the lines from an upper end of the plasma display panel to a lower end of the plasma display panel one at a time.

16. The method of claim 10, wherein selecting the lines to be scanned includes sequential selecting the lines one at a time from one end of an upper panel to another end of the upper panel and from one end of a lower panel to another end of the lower end if the plasma display panel is of dual scan method.

17. The method of claim 10, wherein generating the scan signals includes:
determining whether lines exist having the same data signals as the selected lines; and
generating scan signals so that the selected lines and the lines having the same data signals can be simultaneously scanned when the lines having the same data signals have been determined.

18. The method of claim 17, further comprising generating scan signals so that only the selected lines can be scanned if the lines having the same data signals have not been determined.

19. The method of claim 10, further comprising skipping generation of the scan signals if the selected lines have already been scanned for a particular frame or sub-frame.

20. A plasma display driving method comprising:
comparing a data signal corresponding to one scan line with a data signal corresponding to another scan line; and
simultaneously scanning the one scan line and the other scan line when the data signal corresponding to the one scan line is similar to the data signal of the other scan line.

21. The method of claim 20, wherein the data signals are data signals for one frame.

22. The method of claim 20, wherein the data signals are data signals for one sub-frame.

23. The method of claim 20, where the comparing includes comparing the data signal corresponding to the one scan line with data signals corresponding to the other scan lines.

24. The method of claim 23, further comprising storing information related to scan lines having similar data signals based on the comparing.

25. The method of claim 24, further comprising selecting scan lines for the simultaneously scanning based on the stored information.

26. The method of claim 24, further comprising preventing further scanning of one of the scan lines based on the stored information.

27. A plasma display driving method comprising:
determining scan lines having similar data signals for a particular frame or sub-frame;
simultaneous scanning the determined scan lines having the similar data signals; and
scanning other scan lines having different data signals for the particular frame or sub-frame.

28. The method of claim 27, wherein the data signals are data signals for one frame.

29. The method of claim 27, wherein the data signals are data signals for one sub-frame.

30. The method of claim 27, further comprising storing information related to scan lines having similar data signals based on the determining.

31. The method of claim 30, further comprising selecting scan lines for the simultaneously scanning based on the stored information.

32. The method of claim 30, further comprising preventing further scanning of one of the scan lines based on the stored information.
